(19) United States
(12) Patent Application Publication
(10) Pub. No.: US 2008/0162591 A1
(43) Pub. Date: Jul. 3, 2008

(54) Method of Logging Transactions and a Method of Reversing a Transaction

(75) Inventors: Dipendra Govinddass Ganotra, Iselin, NJ (US); Lakshmi Suresh Goduguluru, Nellore Andhra Pradesh (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/885,558

(22) PCT Filed: Mar. 1, 2005
(86) PCT No.: PCT/IN2005/000076

§ 371 Date: Sep. 4, 2007

(51) Int. Cl. G06F 17/30

(52) U.S. Cl. 707/202

(57) ABSTRACT

A method is disclosed of logging transactions including the steps of storing log records for a plurality of transactions in one or more log files and linking each log record of each individual transaction of the plurality of transactions to any preceding log record of the same transaction so that all log records of each individual transaction are linked. In one embodiment, the method includes the step of maintaining a control record for at least each current transaction that specifies the most recent log record for the transaction to thereby provide a starting point for reserving the transaction if the transaction needs to be reserved.

### FIELD OF THE PRESENT INVENTION

The present invention relates to a method of logging transactions so that all log records of a transaction are linked. The invention also relates to a method of reversing a transaction and to computing systems for logging and reversing transactions.

### BACKGROUND TO THE INVENTION

Transaction rollback (or reversal) requires all activities which have been done by a transaction on one or more databases of a computing system to be reversed. In current systems each time a transaction changes any object in a database the change is recorded in a log file or log files specific to that database. That is, the log records combine the information needed to undo the changes made by the transaction to the database. If changes are made by a transaction to more than one database the activities will be recorded in a log file for each database which is affected. Thus, the order of activities carried out in a database is always preserved.

Typically there are a plurality of log files for each database. The log files are allocated sequential numbers starting from one and continuing with two etc.

Transaction changes on the database are recorded as log records in the log files on a first come, first served basis. Accordingly, if a number of different transactions are current, log records for different transactions will interleave one another in a log file. That is, activities are recorded as log records in the log files in the order that they occurred in the system and not according to the transactions to which they belong. If more than one log file is needed, once the first log file is full, the next log file is used.

In current systems, in order to roll back or reverse a transaction, the system needs to locate all of the activities done by the transaction on all of the databases which it affected. Therefore, the system will start from the last record of the active log file and read backwards, reading each log record from the starting position. For each log record the system will decide whether the record belongs to the transaction that needs to be reversed or to another transaction. If it belongs to another transaction it will discard the record and read the previous record (i.e. the next log record in the reverse direction). The system continues the procedure until it finds a record that is marked to indicate that it is the first record of the transaction that is being reversed. For example, take a set of log files where there are a total of 3,000 log records consisting of 1,000 log records for each of three transactions. In order to reverse a particular transaction the worst case scenario will be that the system has to read all of the 3,000 log records from all the log files. In this case, the system will have to access 2,000 log records that do not relate to the transaction that is required to be rolled back. If these log records are stored on a hard disk, this can mean 2,000 extra disk operations. While buffering techniques can ameliorate this problem to some extent, extra disk operations are only reduced and not eliminated. Further, there will be extra processing requirements on the system in order to read the buffer.

When transaction log records are spanned across multiple log files it may be that a log file does not have any records relating to the transaction that is to be reversed. Nevertheless, if this transaction needs to be reversed, the system will search the entirety of the log file of this database to determine that it does not have any records pertaining to the transaction.

It would be desirable to provide an alternative technique for logging transactions which made reversal of a transaction more efficient.

### SUMMARY

In a first aspect of the invention there is provided a method of logging transactions comprising:

storing log records for a plurality of transactions in one or more log files; and

linking each log record of each individual transaction of the plurality of transactions to any preceding log record of the same transaction so that all log records of each individual transaction are linked.

In a second aspect of the invention there is provided a method of reversing a transaction comprising:

storing log records for a plurality of transactions in one or more log files;

linking each log record of each individual transaction of the plurality of transactions to any preceding log record of the same transaction so that all log records of each individual transaction are linked in a linked list; and

reversing a transaction that requires reversal by traversing the linked list from the most recent log record of the transaction that requires reversal to the first log record of the transaction that requires reversal.

In a third aspect of the invention there is provided a computing system programmed to:

store log records for a plurality of transactions in one or more log files; and

link each log record of each individual transaction of the plurality of transactions to any preceding log record of the same transaction so that all log records of each individual transaction are linked.

In a fourth aspect of the invention there is provided a computing system programmed to:

store log records for a plurality of transactions in one or more log files;

link each log record of each individual transaction of the plurality of transactions to any preceding log record of the same transaction so that all log records of each individual transaction are linked in a linked list; and

reverse a transaction that requires reversal by traversing the linked list from the most recent log record of the transaction that requires reversal to the first log record of the transaction that requires reversal.

### BRIEF DESCRIPTION OF THE DRAWINGS

An embodiment of the invention will now be described with reference to the accompanying drawings in which:

FIG. 1 is a flowchart of a method for logging transactions according to one embodiment of the invention;

FIG. 2 is a schematic diagram showing the relationship between transaction control blocks and transactions in accordance with the method of FIG. 1;

FIG. 3 is a flowchart of a method for reversing a transaction according to an embodiment of the invention; and

FIG. 4 is a schematic diagram of a computing system of the embodiments.

### DETAILED DESCRIPTION OF THE DRAWINGS

A method of logging and reversing transactions will now be described in the context of a computing system where transactions may relate to one or more of three databases and with reference to three transactions. Persons skilled in the art will appreciate that the methods can be used with less than or more than three databases and for as many transactions as required. Furthermore, for convenience, the computing system is described with a single log file for each database. However, persons skilled in the art will appreciate that there will typically be a sequence of log files for each database.

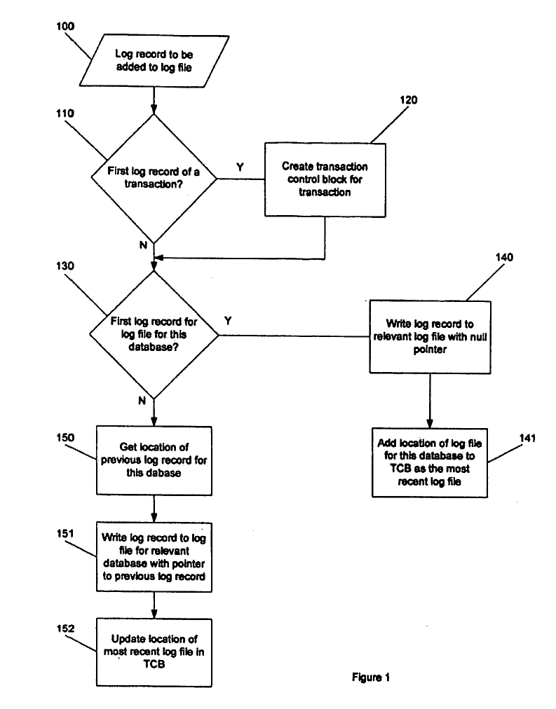

Referring to FIG. 1, the method involves creating a linked list of log records that relates to a transaction. The method creates a linked list of log records for each database's log file. That is, the transaction will have a linked list of log records for each database to which it has made changes.

Referring to FIG. 1, at step 100 a log record is to be added to a log file of one of the databases. At step 110, the method involves determining whether the log record is the first log record of a transaction. If it is determined to be the first log record for a transaction at step 120 a transaction control block for the transaction is created in memory. At step 130, the method involves determining whether this is the first log record of the transaction for this database. In the case of a new transaction or where this is the first log record for this database, the method proceeds to step 140. At step 140 the log record is written to the relevant log file with a null pointer to indicate a null physical location for its previous record—i.e. to indicate that this is the first record of the transaction. The method then involves adding the location of the log record in the log file for the database to the transaction control block for the transaction at step 141. The computing system then takes no further action until a further log record is received to be added to the log file.

When a log record to be added to the log file is received at step 100 and the answers at step 110 and 130 are no—i.e. it is not a new transaction and it is not the first log record for the log file of the database, the method involves getting the location of the previous log record for this database from the transaction control block at step 150. The method then involves writing the newly received log record to the log file for the relevant database with a pointer to the previous log record. That is the pointer points to the location retrieved from the transaction control block. At step 152 the method involves updating the location of the most recent log record in the transaction control block so that the transaction control block can be used to obtain the location of the most recent log record.

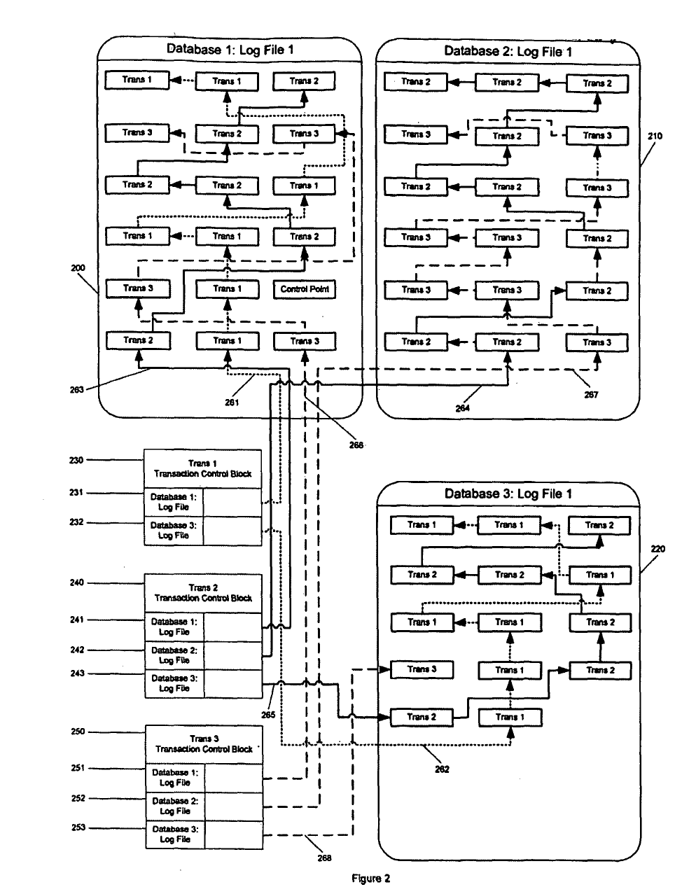

FIG. 2 illustrates an example of the links that may be established between the log records of the various transactions in accordance with this method. In FIG. 2 log records of a first transaction are labelled “Trans 1”, log records of a second transaction are labelled “Trans 2” and log records of a third transaction record are labelled “Trans 3”.

FIG. 2 shows a first log file 200, a second log file 210 and third log file 220 which belong to first second and third databases respectively. As illustrated in FIG. 2, the first transaction, Trans 1 only affects log files 200 and 220 whereas the second and third transaction Trans 2, Trans 3 each affect all of the log files 200, 210 and 220.

The locations of the most recent transaction log record in each database are stored in the transaction control blocks 230, 240 and 250 which correspond to the first, second and third transactions respectively. Thus, the transaction control blocks maintain control records for each transaction that specify the last log record for each of the databases that the transaction has affected.

Referring to transaction control block 230 for the first transaction, this has a control record 231 for the first database which stores the location indicated by arrow 261 and a control record 232 which indicates the location of the most recent log record of transaction one in the third database as indicated by arrow 262.

Transaction control block 240 for the second transaction has log file records 241, 242 and 243 corresponding to the location of the most recent transaction in each of the first, second and third databases as indicated by arrows 263, 264 and 265. Similarly, transaction control block 250 for the third transaction has records 251, 252 and 253 for the locations of the most recent log records of a transaction in each of databases one, two and three as indicated by arrows 266, 267 and 268.

It will thus be appreciated that as indicated by the various lines in FIG. 2, each of the transactions are linked. This allows the transaction to be reversed by following the links from the most recent log record of a particular transaction to the first log record of the transaction which is marked with a null pointer in order that the system knows that they have reached the end of the linked list of log records of the transactions. Accordingly, it will be appreciated that a null pointer is stored in the first transaction location to indicate that it is the last in the linked log records.

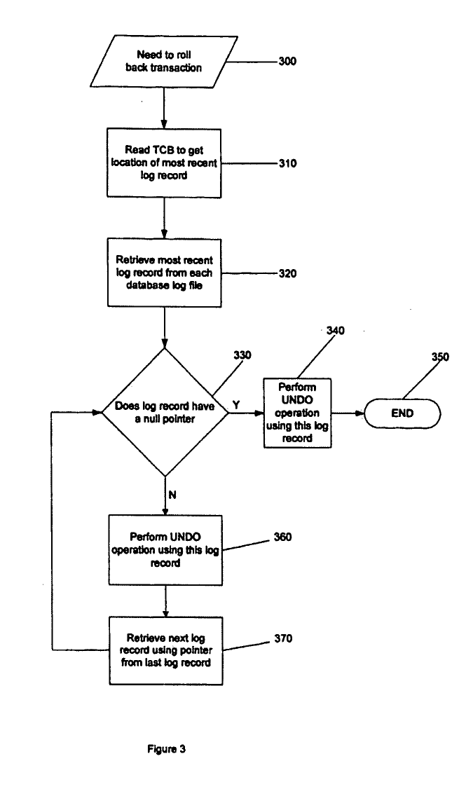

The transaction reversal process will now be described in more detail in relation to FIG. 3. At step 300 the computing system receives a request to reverse a transaction—for example, a transaction has terminated irregularly. At step 310 the system reads the transaction control block for the transaction that needs to be reversed in order to get the location of the most recent log record for each database. The system can thus determine which log files need to be searched in order to reverse the transaction. The system then retrieves the most recent log records from each databases' log file at step 320.

At step 330 the system determines whether the log record has a null pointer. If it does, the system knows that it has reached the end of the set of linked log records. Thus, after performing an undo operation with this log record at step 340, the process ends at step 350. If the log record does not contain a null pointer, the system performs an undo operation using this log record at step 360 and retrieves the next log record using the pointer obtained from the last log record at step 370. The process repeats through step 330 until null pointers are located for each database log file for which there is an entry in the transaction control block. It will thus be appreciated that the computing system does not have to search any log records which do not relate to the transaction that is being rolled back. Further, the computing system does not have to read any log files that were not affected by the transaction.

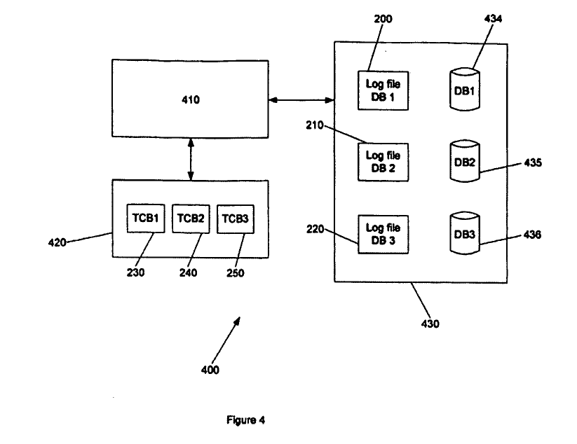

A computing system 400 for carrying out the invention is illustrated schematically in FIG. 4. The computing system 400 incorporates a processor 410 that can read a memory 420 and has access to a storage medium 430. Typically the system 400 uses the processor to process all actions performed on each of the first, second and third databases 434,435,436 stored on the storage medium 430. As the system processes the request to change the database, it stores the log records in log files 200, 210 and 220 which correspond to the first database 434, second database 435 and third database 436 respectively. The system maintains transaction control blocks 230, 240 and 250 in memory 420 for each transaction.

It will be appreciated that depending on the requirements of the system, the processor may maintain the only transaction control blocks for current transactions and delete transaction blocks as and when a transaction completes. Alternatively, the system may store the transaction control block as a file on the storage medium 430 (not illustrated) which incorporates transaction control records for each completed transaction.

These and other modifications will be apparent to persons skilled in the art and should be considered as falling within the scope of the appended claims.

1. A method of logging transactions comprising:
storing log records for a plurality of transactions in one or more log files; and
linking each log record of each individual transaction of the plurality of transactions to any preceding log record of the same transaction so that all log records of each individual transaction are linked.

2. A method as claimed in claim 1 further comprising maintaining a control record for at least each current transaction that specifies the most recent log record for the transaction to thereby provide a starting point for reversing the transaction if the transaction needs to be reversed.

3. A method as claimed in claim 1 comprising marking the first log record of each transaction to indicate that no more log records need to be accessed if a transaction is being reversed.

4. A method as claimed in claim 1 wherein transactions are logged for a plurality of databases each having one or more associated log files and wherein the method comprises separately linking log records of each of the plurality of databases.

5. A method as claimed in claim 4 comprising maintaining a control record for at least each current transaction that specifies the last log record for each of the databases that the transaction has affected.

6. A method as claimed in claim 1 comprising storing log records on a first come first served basis.

7. A method of reversing a transaction comprising:
storing log records for a plurality of transactions in one or more log files;
linking each log record of each individual transaction of the plurality of transactions to any preceding log record of the same transaction so that all log records of each individual transaction are linked in a linked list; and
reversing a transaction that requires reversal by traversing the linked list from the most recent log record of the transaction that requires reversal to the first log record of the transaction that requires reversal.

8. A method as claimed in claim 7 further comprising maintaining a control record for at least each current transaction that specifies the most recent log record for each transaction; and
determining the most recent log record by checking the control record of the transaction that requires reversal.

9. A method as claimed in claim 7 further comprising marking the first log record of each transaction to indicate that no more log records need to be traversed once the first log record is reached.

10. A method as claimed in claim 7 wherein transactions are logged for a plurality of databases each having one or more associated log files and wherein the method comprises separately linking the log records of each of the plurality of databases that each transaction has affected to form a linked list of log records for each database and traversing each of the linked lists to reverse a transaction.

11. A method as claimed in claim 10 comprising:
maintaining a control record for at least each current transaction that specifies the most recent log record that corresponds to each database that the transaction has affected; and
determining the most recent log records to provide a starting point for reversing the transaction by checking the control record of the transaction that requires reversal.

12. A method as claimed in claim 7 comprising storing log records on a first come first served basis.

13. A computing system programmed to:
store log records for a plurality of transactions in one or more log files; and
link each log record of each individual transaction of the plurality of transactions to any preceding log record of the same transaction so that all log records of each individual transaction are linked.

14. A computing system as claimed in claim 13 further programmed to maintain a control record for at least each current transaction that specifies the most recent log record of a transaction to thereby provide a starting point for reversing the transaction if the transaction needs to be reversed.

15. A computing system as claimed in claim 13 further programmed to mark the first log record of each transaction to indicate that no more log records need to be accessed if a transaction is being reversed.

16. A computing system as claimed in claim 13 programmed to log transactions for a plurality of databases each having one or more associated log files and to separately link log records of each of the plurality of databases.

17. A computing system as claimed in claim 13 programmed to maintain a control record for at least each current transaction that specifies the last log record for each of the databases that the transaction has affected.

18. A computing system as claimed in claim 13 programmed to store log records on a first come first served basis.

19. A computing system programmed to:
store log records for a plurality of transactions in one or more log files;
link each log record of each individual transaction of the plurality of transactions to any preceding log record of the same transaction so that all log records of each individual transaction are linked in a linked list; and
reverse a transaction that requires reversal by traversing the linked list from the most recent log record of the transaction that requires reversal to the first log record of the transaction that requires reversal.

20. A computing system as claimed in claim 19 further programmed to:
maintain a control record for at least each current transaction that specifies the most recent log record for each transaction; and
determine the most recent log record by checking the control record of the transaction that requires reversal.

21. A computing system as claimed in claim 19 further programmed to mark the first log record of each transaction to indicate that no more log records need to be traversed once the first log record is reached.

22. A computing system as claimed in claim 19 programmed to:
log transactions for a plurality of databases each having one or more associated log files;
separately link the log records of each of the plurality of databases affected by a transaction to form a linked list for each database; and
traverse each of the linked lists to reverse a transaction that requires reversal.

23. A computing system as claimed in claim 22 programmed to:
maintaining a control record for at least each current transaction that specifies the most recent log record for each database which the transaction has affected; and
determine the most recent log records to provide a starting point for reversing the transaction by checking the control record of the transaction that requires reversal.

24. A computing system as claimed in claim 19 programmed to store log records on a first come first served basis.
